(19) United States
(12) Patent Application Publication
(10) Pub. No.: US 2003/0131340 A1
(43) Pub. Date: Jul. 10, 2003

(54) Creation of a customized command environment

(75) Inventor: James M. McArdle, Austin, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 10/042,493

(22) Filed: Jan. 9, 2002

(51) Int. Cl. G06F 9/44

(52) U.S. Cl. 717/115

(57) ABSTRACT

The invention provides a method of creating a customized command environment. An external command will be launched from the programming application to capture a system command environment. This system command environment will be stored in an array of strings. At least one parameter string will be added to the array of strings. The command will be linked to the command environment with the added parameter string.

### RELATED APPLICATION

This application relates to U.S. Patent Application “Passing Parameters to an External Command via the Command Environment”, by James M. McArdle (IBM Dkt. No. AUS920010927), filed concurrently herewith.

### COPYRIGHT NOTICE

A portion of the disclosure of this patent document contains material which is subject to copyright protection. The copyright owner has no objection to the facsimile reproduction by any-one of the PATENT document or the patent disclosure, as it appears in the Patent and Trademark Office patent file or records, but otherwise reserves all copyright rights whatsoever.

### FIELD OF THE INVENTION

The present invention relates generally to a technique for customizing the command environment.

### BACKGROUND OF THE INVENTION

In many programming applications it often becomes necessary to invoke an external command to perform a specific task. Most languages such as C, C++, and Java provide an API to launch an external command. You may choose to either use the existing command environment established at the time you launched your application or you may create a specific restricted environment for the external command. However, the API does not provide a means to “add-to” the existing command environment.

There is a need for a means whereby programmers can “add-to” the existing command environment and then launch the external command using that environment.

### SUMMARY OF THE INVENTION

One aspect of the present invention is a method of creating a customized command environment. An external command will be launched from the programming application to capture a system command environment. This system command environment will be stored in an array of strings. At least one parameter string will be added to the array of strings. The command will be linked to the command environment with the added parameter string.

Another aspect of the present invention is a computer usable medium launching an external command from the programming application to capture a system command environment; storing the system command environment in an array of strings; adding at least one parameter string to the array of strings; and linking the command environment with the added parameter string.

Another aspect of the present invention is a system for saving selected portions of a Web page to a client local storage comprising means for launching an external command to capture a system command environment; storing the system command environment in an array of strings; adding at least one parameter string to the array of strings; and linking the command to the command environment with the added parameter string.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a flow chart illustrating one embodiment of a method for creating a customized command environment in accordance with the present invention;

FIG. 2 is a code sample illustrating one embodiment of a method for invoking a command to create a customized command environment in accordance with the present invention;

FIG. 3 is a code sample illustrating one embodiment of a method for capturing the default system environment in accordance with the present invention; and

FIG. 4 is a block diagram illustrating one embodiment of a system for creating a customized command environment in accordance with the present invention.

### DETAILED DESCRIPTION OF THE PRESENTLY PREFERRED EMBODIMENTS

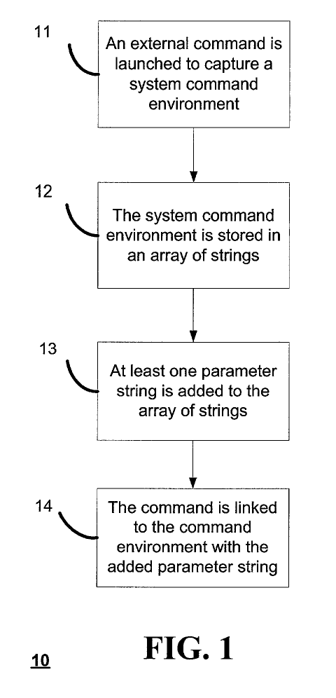

Referring to FIG. 1, one embodiment of a method for creating a customized command environment is generally shown at numeral 10. This example shows a method of creating customized command environment to be used from a programming application. An external command may be launched to capture a system command environment, (Block 11). This command may be any valid command on the operating system being used. Once this command is invoked, the system command environment may be launched. The system command environment may be stored in an array of strings, (Block 12). The array of strings is a data type that may be used to organize the information in memory. At least one parameter string may be added to the array of strings, (Block 13). The command may be linked to the command environment with the added parameter string, (Block 14). Whenever the command is launched the customized command environment may be invoked rather than the system command environment.

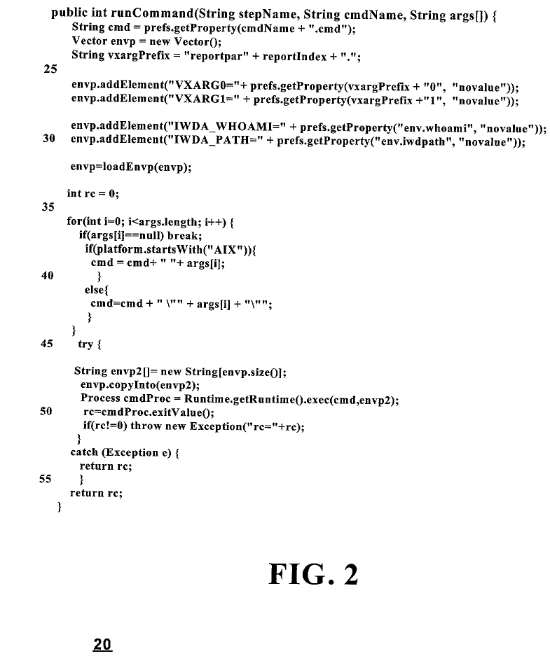

Referring to FIG.2, one embodiment of a method for invoking a command to create a customized command environment is generally shown at numeral 20. Using programming languages known in the art, one implementation of passing parameters within a customized command environment may be used for running IBM's WebSphere Commerce Analyzer Configuration program, which launches vendor provided command scripts

At Block 25 vendor parameters are added into the array of strings that is used to store the customized command environment. At Block 30 the code adds specific product parameters into the array of strings that is storing the customized command environment. Block 30 then invokes the loadEnvp command to create the customized command environment with the added parameters. Blocks 35 and 40 get the command ready to execute. Block 50 runs the command with the customized command environment, including the added parameters.

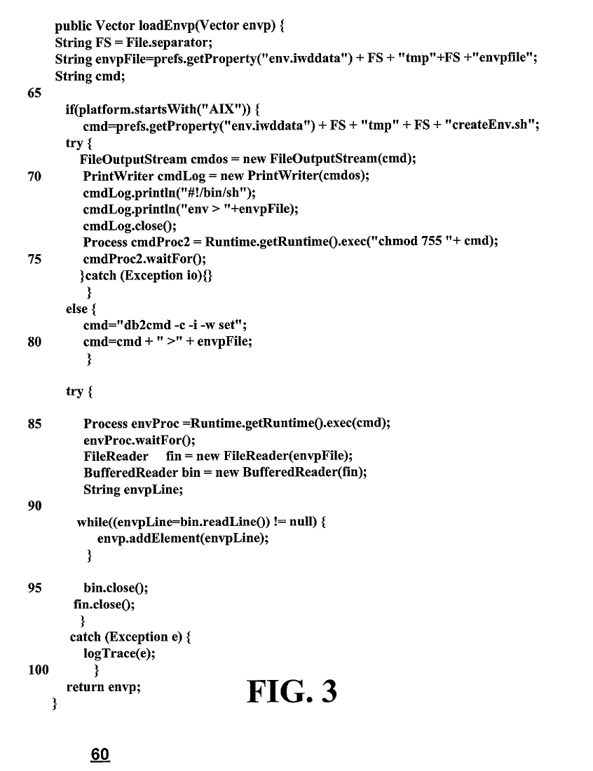

Referring to FIG. 3, one embodiment of a method for capturing the default system environment is generally shown at numeral 60. Using programming languages known in the art, one implementation of the creation of a command environment may be used for running IBM's WebSphere Commerce Analyzer Configuration program, which launches vendor provided command scripts.

At Block 65 the operating system running on the current server is determined. Separate code will be executed depending on which operating system is being used. At Blocks 65 and 70, AIX specific code is used to capture the system command environment. If AIX is not the current operating system, Blocks 75 and 80 will be executed to capture the system command environment for Windows operating systems. Finally, at Blocks 85 and 90 the environment will be read back from memory and stored in an array of strings.

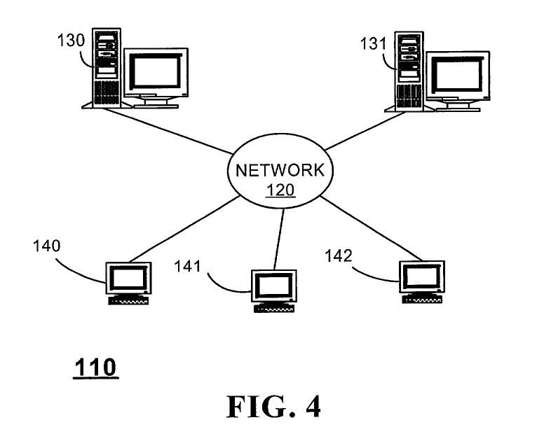

Referring to FIG. 4, one embodiment of a system for passing parameters within a customized command environment is generally shown at numeral 110. In this example, the shown system may be a general network comprising clients and servers. This network, 120, may provide communication links between various devices and computers connected together within this environment. Network 120 may include permanent connections, such as wire or fiber optic cables, or temporary connections made through telephone or wireless communications.

In the example shown, one or more servers, depicted at 130 and 131, may be used for running network software applications. Clients 140, 141, and 142 may also exist within the environment and may represent individual users on the system.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method of creating a customized command environment comprising:
launching an external command to capture a system command environment;
storing the system command environment in an array of strings;
adding at least one parameter string to the array of strings; and
linking the command to the command environment with the added parameter string.

2. The method of claim 1 wherein the external command is any invocation of an external command to perform a predetermined task.

3. The method of claim 1 wherein the external command is launched from within a programming application.

4. The method of claim 1 wherein the additional parameter string added to the array of strings may include variables to be passed to the customized command environment.

5. A computer usable medium storing a program for creating a specialized command environment comprising:
computer readable code to launch an external command to capture a system command environment;
computer readable code to store the system command environment in an array of strings;
computer readable code to add at least one parameter string to the array of strings; and
computer readable code to link the command environment with the added parameter string.

6. The computer usable medium of claim 5 wherein the external command is any invocation of an external command to perform a predetermined task.

7. The computer usable medium of claim 5 wherein the external command is launched from within a programming application.

8. The computer usable medium of claim 5 wherein the additional parameter string added to the array of strings may include variables to be passed to the customized command environment.

9. A system for creating a specialized command environment comprising:
means for launching an external command to capture a system command environment;
means for storing the system command environment in an array of strings;
means for adding at least one parameter string to the array of strings; and
means for linking the command to the command environment with the added parameter string.
